(19) United States
(12) Patent Application Publication
(10) Pub. No.: US 2007/0220231 A1
(43) Pub. Date: Sep. 20, 2007

(54) Virtual address translation by a processor for a peripheral device

(76) Inventors: Sridharan Sakthivelu, DuPont, WA (US); John L. Baudrexl, Olympia, WA (US)

Correspondence Address: INTEL CORPORATION;c/o INTELLEVATE, LLC, P.O. BOX 52050, MINNEAPOLIS, MN, 55402, US

(21) Appl. No.: 11/385,242

(22) Filed: Mar. 20, 2006

(51) Int. Cl. G06F 12/00

(52) U.S. Cl. 711/203

(57) ABSTRACT

Processors, systems, and methods for virtual address translation by a processor for a peripheral device are disclosed. In one embodiment, a processor includes a memory management unit and an interface. The memory management unit is to translate a first address to a second address. The first address is an address usable by software to access the virtual memory space of the processor. The second address is an address usable by the processor to access the physical memory space of the processor. The interface is to receive the first address from a peripheral device, to receive a request to translate the first address, and to transmit the second address to the peripheral device for the peripheral device to use to access the physical memory space of the processor.

### BACKGROUND

1. Field

The present disclosure pertains to the field of information processing, and, more specifically, to the field of memory management.

2. Description of Related Art

Many information processing systems utilize the concept of virtual memory to provide software with an address space for storing and accessing code and data that is larger than the address space of the physical memory in the system. The virtual memory space of a processor may be limited only by the number of address bits available to software running on the processor, while the physical memory space of the processor is further limited to the size of random access or other main memory available to the processor. Hardware and/or operating system (“OS”) software may be used to implement a memory management scheme such as paging to swap the executing software's code and data in and out of main memory on an as-needed basis. As part of this scheme, the software may access the virtual memory space of the processor with a first address that is translated by the processor to a second address that the processor may use to access the physical memory space of the processor.

In addition to the processor accessing the physical memory of the system as described above, a peripheral device in the system, such as a network controller or other bus master, may be able to access the physical memory of the system, for example, through a technique known as direct memory access. These peripheral devices may access physical memory using a physical memory address. Alternatively, these peripheral devices and/or a chipset, bus bridge, or other system logic component may translate an address used by the peripheral device to a physical memory address.

### BRIEF DESCRIPTION OF THE FIGURES

The present invention is illustrated by way of example and not limitation in the accompanying figures.

FIG. 1 illustrates an embodiment of the invention in a processor including virtual address translation logic for a peripheral device

FIG. 2 illustrates virtual to physical address translation in an embodiment of the invention in a system supporting a virtualized computing environment.

FIG. 3 illustrates an embodiment of the invention in a method in a method of virtual address translation by a processor for a peripheral device.

### DETAILED DESCRIPTION

The following description describes embodiments of techniques for virtual address translation by a processor for a peripheral device. In the following description, numerous specific details such as processor and system configurations are set forth in order to provide a more thorough understanding of the present invention. It will be appreciated, however, by one skilled in the art that the invention may be practiced without such specific details. Additionally, some well known structures, circuits, and the like have not been shown in detail, to avoid unnecessarily obscuring the present invention.

Embodiments of the present invention provide for virtual address translation by a processor for a peripheral device. Techniques according to embodiments of the present invention may be implemented using or in conjunction with translation hardware already designed into a processor, such the paging logic and translation lookaside buffer (“TLB”) of a memory management unit (“MMU”). Therefore, the full benefit of such techniques may be realized at an incremental cost. Also, techniques according to embodiments of the present invention may be used in a virtualized computing environment in which software may be run on a virtual machine (“VM”) within an information processing system, where the VM may appear to the software to be an isolated system, including a main memory, peripheral devices, and other resources, over which the software has complete control, when in fact the resources may be shared. Therefore, peripheral devices may access main memory in a virtualized computing environment without costly translation schemes implemented outside the processor.

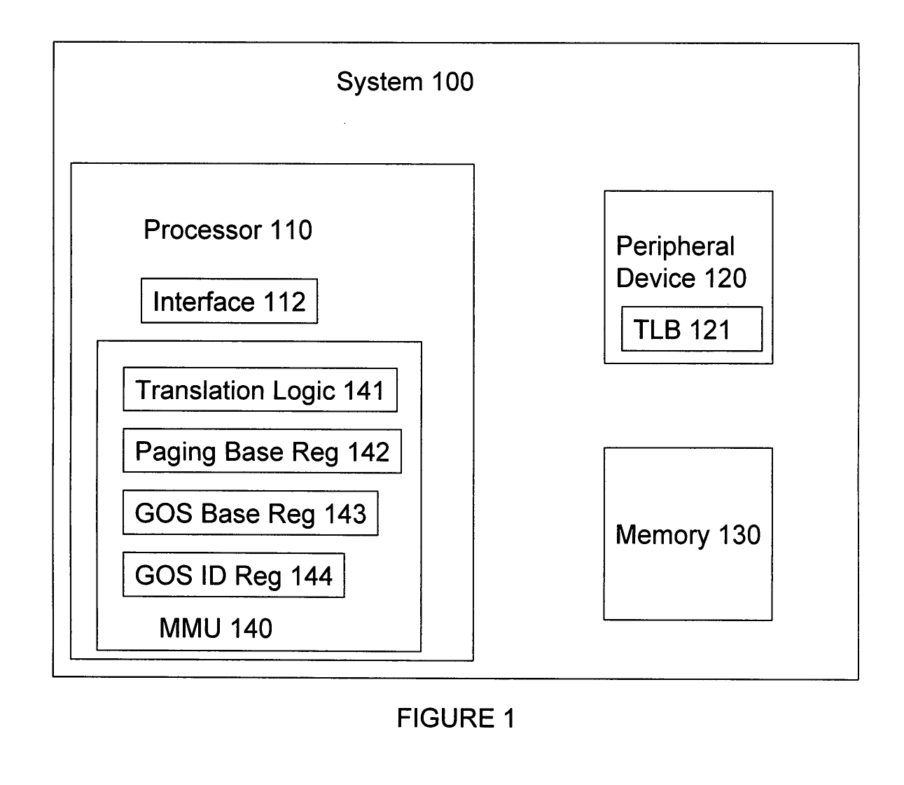

FIG. 1 illustrates an embodiment of the invention in a processor, processor 110, including logic for virtual address translation for peripheral device 120. Processor 110 and peripheral device 120 are shown in system 100, which also includes memory 130.

Processor 110 may be any of a variety of different types of processors, such as a processor in the Pentium® Processor Family, the Itanium® Processor Family, or other processor family from Intel Corporation, or any other general purpose or other processor from another company. In the embodiment of FIG. 1, processor 110 includes interface 112 and MMU 140. Interface 112 may be a bus unit or any other unit, port, or interface to allow processor 110 to communicate with peripheral device 120 through any type of bus, point to point, or other connection, directly or through any other component, such as a chipset or a bus bridge or controller. MMU 140 includes translation logic 141, paging base register 142, guest OS (“GOS”) table base register 143, and GOS identifier (“ID”) register 144.

Translation logic 141 is to perform address translations, for example the translation of a virtual address to a physical address, according to any known memory management technique, such as paging. As used herein, the term “virtual address” includes any address referred to as a logical or a linear address. To perform these address translations, translation logic 141 refers to one or more data structures stored in processor 110, memory 130, any other storage location in system 100 not shown in FIG. 1, and/or any combination of these components and locations. The data structures may include page directories and page tables according to the architecture of the Pentium® Processor Family, as modified according to embodiments of the present invention, and/or a table stored in a TLB.

In one embodiment, translation logic 141 receives a linear address provided by an instruction to be executed by processor 110. Translation logic 141 uses portions of the linear address as indices into hierarchical tables, including page tables, to perform a page walk. The page tables contain entries, each including a field for a base address of a page in memory 130, for example, bits 39:12 of a page table entry according to the Pentium® Processor Family's Extended Memory 64 Technology. Any page size (e.g., 4 kilobytes) may be used within the scope of the present invention. Therefore, the linear address used by a program to access memory 130 may be translated to a physical address used by processor 110 to access memory 130.

Paging base register 142 may be any register or other storage location used to store a pointer to a data structure used by translation logic 141. In one embodiment, paging base register 142 may be that portion of the CR3 register referred to as PML4 Base, used to store the page map level 4 base address, according to the architecture of the Pentium® Processor Family.

Interface 112 includes logic to receive and transmit communications, for example bus transactions, from and to other devices or components in system 100. In one such communication, processor 110 may receive an address provided by peripheral device 120 for translation by processor 110. The address may be a virtual address according to the view of the virtual memory of processor 110 as seen by software running on processor 110. In the same or an additional communication, processor 110 may receive a request to translate that address to a physical address that peripheral device 120 may use to access memory 130. In the same or an additional communication, processor 110 may transmit the physical address to peripheral device 120. Any of these communications may be passed through and/or translated by another component in system 100, such as a bus bridge. For example, interface 112 may be an interface to a processor bus, peripheral device 120 may reside on a peripheral bus, and a bus bridge may be used to translate transactions between the processor bus protocol and the peripheral bus protocol.

Embodiments of the present invention include a protocol for peripheral device 120 to request processor 110 to translate a virtual address to a physical address. For example, peripheral device 120 may issue a bus command including a virtual address on a peripheral bus. Processor 110, or a bus bridge or other component, may recognize the bus command as a request to translate the virtual address, based on control signals and/or the type or length of the address signals. In an embodiment with a bus bridge or other component between peripheral device 120 and processor 110, the peripheral bus transaction may be translated to a processor bus transaction. Therefore, peripheral device 120 may request processor 110 to translate a virtual address to a physical address.

In processor 110, translation logic 141 performs the virtual to physical address translation. Interface 112 transmits the physical address to peripheral device 120 for peripheral device 120 to use to access memory 130. Peripheral device 120 may include device TLB 121, which may be used to store the virtual address sent by peripheral device 120 and the corresponding physical address returned by processor 110, so that the appropriate physical address for future memory accesses by peripheral device 120 using the same virtual address may be found in device TLB 121 and another translation by processor 110 is not required. An additional communication from processor 120 may be used to flush the contents of device TLB 121 when appropriate, for example on a software context switch.

Embodiments of the present invention may also be implemented in a system supporting a virtualized computing environment. Generally, the concept of virtualization of resources in information processing systems allows multiple instances of one or more OSes to run on a single information processing system, even though each OS is designed to have complete, direct control over the system and its resources. Virtualization is typically implemented by using software (e.g., a virtual machine monitor, or a “VMM”) to present to each OS a VM having virtual resources that the OS may completely and directly control, while the VMM maintains a system environment for implementing virtualization policies such as sharing and/or allocating the physical resources among the VMs (the “virtualized computing environment”). Each OS, and any other software, that runs on a VM is referred to as a “guest” or as “guest software,” while a “host” or “host software” is software, such as a VMM, that maintains the virtualized computing environment.

A processor in an information processing system may support virtualization, for example, by supporting an instruction to enter a virtualized computing environment to run a guest on a VM. In the virtualized computing environment, certain events, operations, and situations, such as external interrupts or attempts to access privileged registers or resources, may be “intercepted,” i.e., cause the processor to exit the virtualized computing environment so that a VMM may operate, for example, to implement virtualization policies. A processor may also support other instructions for maintaining a virtualized computing environment, and may include register bits that indicate or control virtualization capabilities of the processor.

The system's privileged resources may include peripheral devices such as peripheral device 120, which may be dedicated to or shared by one or more virtual machine. Such peripheral device may be capable of accessing system memory, but the address that they use to access system memory must be translated from the view of system memory of the guest controlling the peripheral device to a physical memory address. This translation would typically include a translation from a virtual address, as described above, to a physical address, because the guest view of memory is typically a view of a virtual address space. However, the translation would also typically include a translation from the guest's view of the physical address space to the host's view of the physical address space, to enforce virtualization policies that allow the host to share system memory between guests. Both of these translations may be performed by the processor for the peripheral device according to embodiments of the present invention.

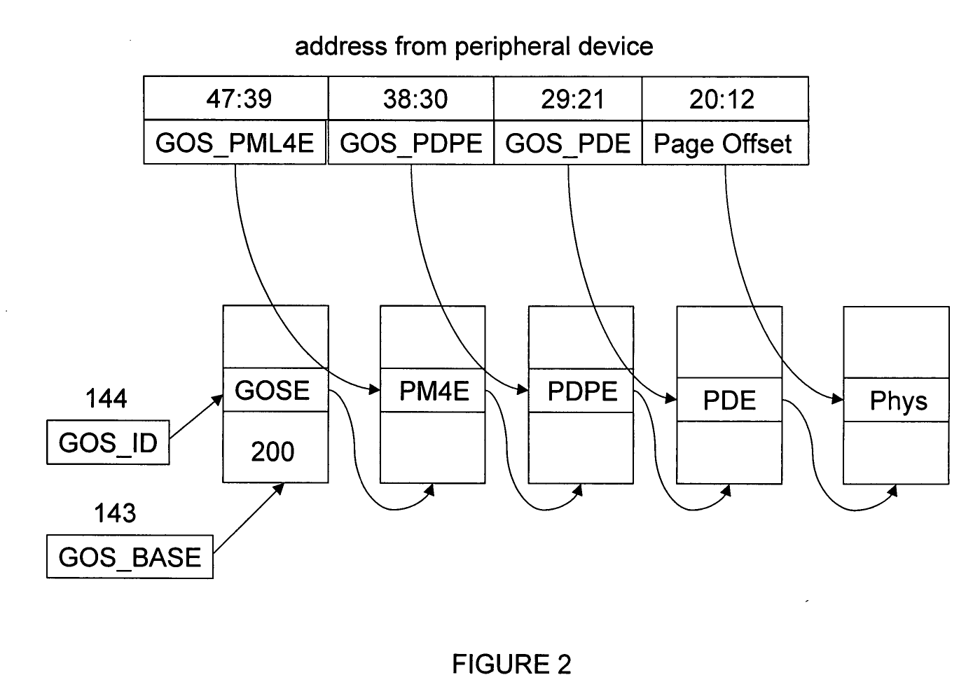

Virtual to physical address translation in an embodiment of the invention in a system supporting a virtualized computing environment is illustrated in FIG. 2, with reference to the hardware of FIG. 1. In FIG. 2, GOS table 200 may be a table or any other data structure including entries corresponding to GOSes running on system 100. Each entry includes a pointer to a data structure used by translation logic 141 to translate a virtual address according to the GOS's view of memory to a physical address, according to any address translation approach as described above. In one embodiment, each such pointer may be a copy of or a substitute for the paging pointer stored in paging base register 142, such that the address translation may be performed using the same page walk mechanism that the processor uses for other virtual to physical address translations, but using an analogous data structure with potentially different contents. For example, each such pointer may be used as a copy of or a substitute for the PML4 Base portion of the CR3 register according to the architecture of the Pentium® Processor Family.

MMU 140 includes GOS table base register 143 to store a pointer to GOS table 200, for example, the base address of the location in memory 130 where GOS table 200 is stored. GOS table base register 143 may be any register or other type of storage location.

MMU 140 also includes GOS ID register 144 to store an identifier of the currently running GOS. Each GOS in the virtualized computing environment of system 100 may have a unique identifier that may be used directly or indirectly as an index into GOS table 200. As part of the protocol for peripheral device 120 to request an address translation, a communication from peripheral device 120 to processor 110 may include a GOS ID to identify the GOS that is in control of peripheral 120 at the time of the request. This GOS ID may then be used to find the appropriate GOS entry in GOS table 200.

Although FIG. 1 shows a single processor and a single peripheral device, other embodiments of the present invention may include more than one processor or processor core. In such embodiments, each processor or processor core may have its own MMU, including its own paging base register, GOS table base register, and GOS ID register. Embodiments of the present invention may also include more than one peripheral device for which a processor may perform virtual address translations. In such embodiments, each peripheral device may be any type of peripheral device, such as a network controller or any other input/output device. In addition, memory 130 may be static or dynamic random access memory, semiconductor-based read only or flash memory, magnetic or optical disk memory, any other type of medium readable by processor 110, or any combination of such mediums.

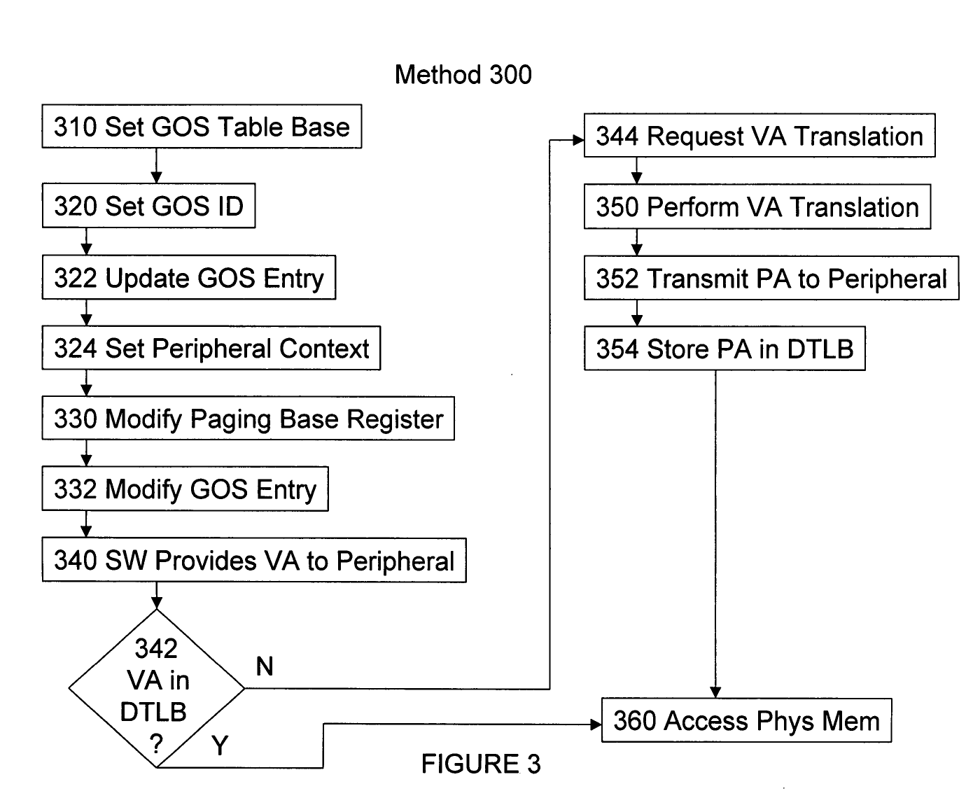

FIG. 3 is a flowchart of method 300, a method of virtual address translation by a processor for a peripheral device. In block 310, a VMM running on a multicore processor sets a GOS table base register for each core, as part of the process of booting the core.

In block 320, in preparation for a GOS to begin running on a VM on one of the cores, the GOS ID register for that core is set to a value to represent that GOS. In block 322, the GOS table entry corresponding to the currently running GOS ID is updated with a pointer to the appropriate paging data structure along with any other information related to that GOS, such as VM entry, control, and exit parameters. In block 324, the VMM sets up the peripheral device context associated with the GOS, for example by setting a configuration register in the peripheral device to reflect the GOS ID.

In block 330, while the GOS is running, the GOS modifies the contents of the core's paging base register. In block 332, the updated contents of the core's paging base register are copied to the current GOS table entry.

In block 340, software running within the current GOS provides the peripheral device with the appropriate virtual address for the peripheral device to operate on. In block 342, the peripheral device checks its own TLB to determine if it contains a previous translation for that virtual address. If so, method 300 continues at block 360. If not, then, in block 344, the peripheral device requests a virtual address translation by the processor, including transmitting the virtual address and the GOS ID to the processor.

In block 350, the processor performs the virtual address translation using the data structure pointed to by the GOS table entry corresponding to the GOS ID sent by the peripheral device. In block 352, the processor transmits the physical address found by the translation to the peripheral device. In block 354, the peripheral device stores the physical address in an entry in its TLB corresponding to the virtual address for which translation was requested.

In block 360, the peripheral device accesses memory using the physical address transmitted to it by the processor or found in the peripheral device's TLB.

Within the scope of the present invention, method 300 may be performed in a different order, with illustrated blocks performed simultaneously, with illustrated blocks omitted, with additional blocks added, or with a combination of reordered, combined, omitted, or additional blocks.

Processor 110, or any other processor or component designed according to an embodiment of the present invention, may be designed in various stages, from creation to simulation to fabrication. Data representing a design may represent the design in a number of manners. First, as is useful in simulations, the hardware may be represented using a hardware description language or another functional description language. Additionally or alternatively, a circuit level model with logic and/or transistor gates may be produced at some stages of the design process. Furthermore, most designs, at some stage, reach a level where they may be modeled with data representing the physical placement of various devices. In the case where conventional semiconductor fabrication techniques are used, the data representing the device placement model may be the data specifying the presence or absence of various features on different mask layers for masks used to produce an integrated circuit.

In any representation of the design, the data may be stored in any form of a machine-readable medium. An optical or electrical wave modulated or otherwise generated to transmit such information, a memory, or a magnetic or optical storage medium, such as a disc, may be the machine-readable medium. Any of these mediums may “carry” or “indicate” the design, or other information used in an embodiment of the present invention, such as the instructions in an error recovery routine. When an electrical carrier wave indicating or carrying the information is transmitted, to the extent that copying, buffering, or re-transmission of the electrical signal is performed, a new copy is made. Thus, the actions of a communication provider or a network provider may be making copies of an article, e.g., a carrier wave, embodying techniques of the present invention.

Thus, techniques for virtual address translation by a processor for a peripheral device are disclosed. While certain embodiments have been described, and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principles of the present disclosure or the scope of the accompanying claims.

What is claimed is:

1. A processor comprising:
a memory management unit to translate a first address usable by software to access the virtual memory space of the processor to a second address usable by the processor to access the physical memory space of the processor; and
an interface to:
receive the first address from a peripheral device,
receive a request to translate the first address, and
transmit the second address to the peripheral device for the peripheral device to use to access the physical memory space of the processor.

2. The processor of claim 1, wherein the memory management unit includes a storage location to store a pointer to a data structure to be used to translate the first address to the second address.

3. The processor of claim 2, wherein the first data structure includes a page table.

4. The processor of claim 1, wherein the interface is also to receive an identifier from the peripheral device, and the identifier is to be used to identify a first pointer to a first data structure to be used to translate the first address to the second address.

5. The processor of claim 4, wherein the memory management unit includes a storage location to store a second pointer to a second data structure to be used to store the first pointer.

6. The processor of claim 5, wherein the second data structure includes a table to store a plurality of entries to correspond to a plurality of guest operating systems, each guest operating system to control a virtual machine supported by the processor.

7. The processor of claim 6, wherein the identifier is to be used as an index into the table to identify one of the plurality of entries, and the one of the plurality of entries is to include the first pointer.

8. A method comprising:
transmitting a request for a virtual address translation to a processor;
translating the virtual address to a physical address using the processor's memory management unit; and
transmitting the physical address to a peripheral device for the peripheral device to use to access memory.

9. The method of claim 8, further comprising transmitting the virtual address from the peripheral device to the processor.

10. The method of claim 9, further comprising transmitting a guest identifier from the peripheral device to the processor.

11. The method of claim 10, further comprising using the guest identifier as an index into a first data structure to identify a second data structure to use to translate the virtual address to the physical address.

12. The method of claim 11, wherein the first data structure includes a table of guest operating system entries, each guest operating system entry corresponding to a guest operating system to control a virtual machine supported by the processor.

13. The method of claim 12, wherein the second data structure includes a page table.

14. A system comprising:
a memory;
a peripheral device coupled to the memory; and
a processor coupled to the memory, including:
a memory management unit to translate a first address usable by software to access the virtual memory space of the processor to a second address usable by the processor to access the physical memory space of the processor, and
an interface to:
receive the first address from the peripheral device,
receive a request to translate the first address, and
transmit the second address to the peripheral device for the peripheral device to use to access the memory.

15. The system of claim 14, wherein the memory management unit includes a storage location to store a pointer to a data structure to be used to translate the first address to the second address.

16. The system of claim 14, wherein the interface is also to receive an identifier from the peripheral device, and the identifier is to be used to identify a first pointer to a first data structure to be used to translate the first address to the second address.

17. The system of claim 16, wherein the memory management unit includes a storage location to store a second pointer to a second data structure to be used to store the first pointer.

18. The system of claim 17, wherein the second data structure includes a table to store a plurality of entries to correspond to a plurality of guest operating systems, each guest operating system to control a virtual machine supported by the processor.

19. The system of claim 18, wherein the identifier is to be used as an index into the table to identify one of the plurality of entries, and the one of the plurality of entries is to include the first pointer.

20. The system of claim 14, wherein the peripheral device includes a data structure to store the first address and the second address.
